(19) United States
(12) Patent Application Publication
(10) Pub. No.: US 2011/0116884 A1
(43) Pub. Date: May 19, 2011

(54) HELICAL BIT TOOL

(75) Inventor: Shiqing Li, Shandong (CN)

(73) Assignee: SHIQING LI, Xinwen Xintai (CN)

(21) Appl. No.: 12/933,324

(22) PCT Filed: Mar. 19, 2008
(86) PCT No.: PCT/CN2008/000546

§ 371 Date: Jan. 27, 2011

(51) Int. Cl. B23B 51/02

(52) U.S. Cl. 408/223; 408/230

(57) ABSTRACT

A helical bit tool includes a bit head (1) with multiple helical pieces (2). Each helical piece has a side cutting edge (3) which faces on the direction of cutting operation. The surface of the side cutting edge which faces on the direction of cutting operation forms a cutting face (4). The back surface of the cutting face forms a rear cutting face (5). The step area (7) is formed on the top surface (6) of the bit head, in which forming a step or multiple steps with progressively lower heights from the center of the top surface to the outer flank. The periphery of every step is inclined with respect to the periphery of the bit head. A chamfering surface (9) is formed on where the rear cutting face interfaces with the step area and the top surface of the bit head. An upright cutting face (15) is formed on the side of the chamfering surface near the center of the top surface. The intersection of the chamfering surface, the step area and the top surface of the bit head forms a rear cutting edge (10). The intersection of the upright cutting face and the step area at its back side forms a chisel (11).

### TECHNICAL FIELD

The present invention relates to a helical bit tool, which is used in machining of drill press, milling machine, boring machine, etc.

### BACKGROUND ART

Currently, twist drill used in machining is composed of chisel edge, cutting edge, helical side edge. The side edge is generally in single convexity. Although the side edge and cutting edge of the milling cutter are structured with three edges, four edges, five edges, etc., which are provided in distribution, there is no significant difference between its side edge and cutting edge and those of the twist drill. When drilling (milling) harder work pieces, these twist drills and milling cutters tend to produce a large amount of heat. As a result, the rigidity of the bit head will decreases, resulting in abrasion of the bit head, and such bit head also tends to be broken. Moreover, since the cutting edges on both sides of the bit head are symmetry during operation, and the cutting amount is generally from about some dozens of micrometers to one millimeter, it is difficult to control grinding angle height. Moreover, since it is difficult to control central position of the bit head of these twist drills and milling cutters, it tends to result in inaccurate positioning, unqualified machining precision of holes, and it is very likely to result in defective product. Meanwhile, when machining thinner work piece, there is also a problem of causing work accident by bringing up the work piece.

### SUMMARY OF THE INVENTION

The present invention is made in view of the above problems so as to provide a novel helical bit tool, which has high heat dissipation efficiency, high strength, long lifetime and can be easily positioned when drilling machining.

In order to achieve the above object, the present invention employs the following technical solution:

A helical bit tool, comprising a bit head, characterizing in that: the bit head is integratively provided with multiple helical pieces, each helical piece has a side cutting edge which faces the direction of cutting operation, the surface of the side cutting edge which faces the direction of cutting operation forms a cutting face, the back surface of the cutting face forms a rear cutting face, step area is formed on the top surface of the bit head, in which a step or multiple steps are formed with progressively lower heights from the center of the top surface to the outer flank, the periphery of every step is inclined with respect to the periphery of the bit head, a main cutting edge is formed on where the cutting face interfaces with the step area and the top surface of the bit head, a chamfering surface is formed on where the rear cutting face interfaces with the step area and the top surface of the bit head, an upright cutting face is formed on the side of the chamfering surface near the center of the top surface, the intersection of the chamfering surface with the step area and the top surface of the bit head forms a rear cutting edge. The intersection of the upright cutting face and the step area at its back side forms a chisel edge.

Preferably, one heat dissipation stage or multiple heat dissipation stages are formed on the peripheral surface of the helical pieces from the top surface of the bit head and are parallel to the side cutting edge, one heat dissipation stage side cutting edge or multiple heat dissipation stage side cutting edges are formed in the front of the heat dissipation stage facing the direction of cutting operation.

Preferably, one arc groove or multiple arc grooves are formed respectively on each step and the top surface outside the step area, and the arc grooves extend from the main cutting edge to the rear cutting edge with their openings enlarge gradually.

A helical bit tool, comprising a bit head, characterizing in that: the bit head is integratively provided with multiple helical pieces, each helical piece has a side cutting edge which faces the direction of cutting operation, the surface of the side cutting edge which faces the direction of cutting operation forms a cutting face, the back surface of the cutting face forms a rear cutting face, a main cutting edge is formed on where the top surface of the bit head interfaces with the cutting face, a chamfering surface is formed on where the rear cutting face interfaces with the top surface of the bit head, an upright cutting face is formed on the side of the chamfering surface near the center of the top surface, t he intersection of the chamfering surface and the top surface of the bit head forms a rear cutting edge, the intersection of the upright cutting face and the step area at its back side forms a chisel edge, one arc groove or multiple arc grooves are formed on the top surface and extend from the main cutting edge to the rear cutting edge with their openings enlarge gradually.

Preferably, one heat dissipation stage or multiple heat dissipation stages are formed on the peripheral surface of the helical pieces from the top surface of the bit head and are parallel to the side cutting edge, one heat dissipation stage side cutting edge or multiple heat dissipation stage side cutting edges are formed in the front of the heat dissipation stage facing the direction of cutting operation.

A helical bit tool, comprising a bit head, characterizing in that: the bit head is integratively provided with multiple helical pieces, each helical piece has a side cutting edge which faces on the direction of cutting operation, the surface of the side cutting edge which faces on the direction of cutting operation forms a cutting face, the back surface of the cutting face forms a rear cutting face, a main cutting edge is formed on where the top surface of the bit head interfaces with the cutting face, a chamfering surface is formed on where the rear cutting face interfaces with the top surface of the bit head, an upright cutting face is formed on the side of the chamfering surface near the center of the top surface, t he intersection of the chamfering surface and the top surface of the bit head forms a rear cutting edge, the intersection of the upright cutting face and the step area at its backside forms a chisel edge, one heat dissipation stage or multiple heat dissipation stages are formed on the peripheral surface of the helical pieces from the top surface of the bit head and are parallel to the side cutting edge, one heat dissipation stage side cutting edge or multiple heat dissipation stage side cutting edges are formed in the front of the heat dissipation stage facing the direction of cutting operation.

Preferably, two helical pieces are formed, and an alloy bit head with uniform thickness is clipped on the bit head, which penetrates the bit head and is symmetry with respect to the center of the top surface, two faces of the alloy bit head facing the direction of cutting operation pass through two intersections of the top edge and the main cutting edge respectively, the face of the alloy bit head facing the direction of cutting operation forms an upper part of the cutting surface, and the cutting edge facing the direction of cutting operation forms the main cutting edge.

### DESCRIPTION OF THE DRAWINGS

The technical solution and advantages of the present invention will be described in detail with reference to the drawings, wherein:

FIG. 1 is a schematic graph of the helical bit tool in accordance with the first embodiment of the present invention;

FIG. 2 is a schematic graph of the helical bit tool in accordance with the second embodiment of the present invention;

FIG. 3 is a schematic graph of the helical bit tool in accordance with the third embodiment of the present invention;

FIG. 4 is a schematic graph of the helical bit tool in accordance with the fourth embodiment of the present invention;

FIG. 5 is a schematic graph of the helical bit tool in accordance with the fifth embodiment of the present invention;

FIG. 6 is a schematic graph of the helical bit tool in accordance with the sixth embodiment of the present invention;

FIG. 7 is a schematic graph of the helical bit tool in accordance with the seventh embodiment of the present invention;

FIG. 8 is a schematic graph of the helical bit tool in accordance with the eighth embodiment of the present invention.

### DETAILED DESCRIPTION FOR CARRYING OUT THE INVENTION

Description is now made in detail with reference to preferred embodiment of helical bit tool of the present invention in conjuction with the drawings. In embodiments 1-8, description is made mainly with reference to bit tool with two helical pieces. In the following description, same numeral signs are used for same parts, of which the detailed description is omitted.

Embodiment 1

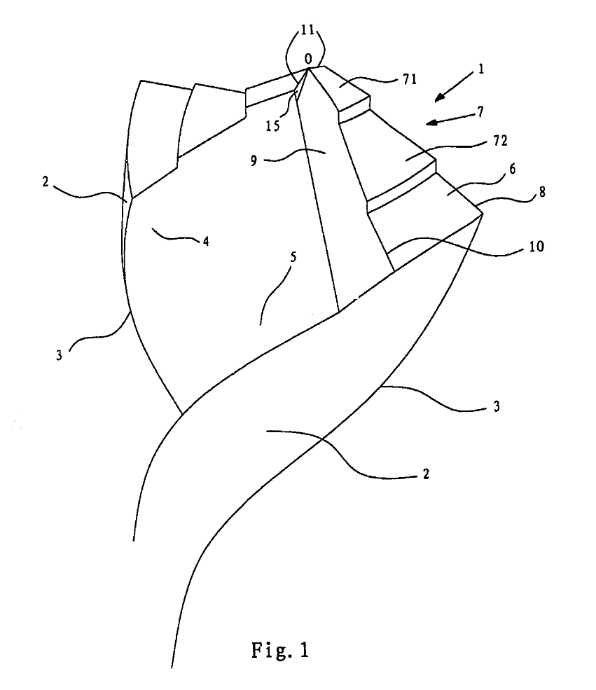

As illustrated in FIG. 1, the helical bit tool of the first embodiment of the present invention comprises: a bit head 1, which is integratively provided with two helical pieces 2, each helical piece 2 has a side cutting edge 3 which faces on the direction of cutting operation. The surface of the side cutting edge 3 which faces on the direction of cutting operation forms a cutting face 4. The back surface of the cutting face 4 forms a rear cutting face 5. The step area 7 is formed on the top surface 6 of the bit head 1, in which a step or multiple steps are formed with progressively lower heights from the center O of the top surface to the outer flank. In this embodiment, two steps 71, 72 are formed. The periphery of every step is inclined with respect to the periphery of the bit head 1. A main cutting edge 8 is formed on where the cutting face 4 interfaces with the step area 7 and the top surface 6 of the bit head. A chamfering surface 9 is formed on where the rear cutting face 5 interfaces with the step area 7 and the top surface 6 of the bit head. An upright cutting face 15 is formed on the side of the chamfering surface 9 near the center O of the top surface. The intersection of the chamfering surface 9, the step area 7 and the top surface 6 of the bit head forms a rear cutting edge 10. The intersection of the upright cutting face and the step area at its back side forms a chisel edge 11.

According to the above structure, step area 7 is formed on the top surface 6 of the bit tool 1, in which a step or multiple steps 71 . . . 7n are formed with progressively lower heights from the center O of the top surface to the outer flank and the periphery of every step is inclined with respect to the periphery of the bit head 1, a main cutting edge 8 is formed on where the cutting face 4 interfaces with the step area 7 and the top surface 6 of the bit head, a chamfering surface 9 is formed on where the rear cutting face 5 interfaces with the step area 7 and the top surface 6 of the bit head, an upright cutting face 15 is formed on the side of the chamfering surface near the center of the top surface, and the intersection of the upright cutting face 15 and the step area at its backside forms a chisel edge 11, so that in comparison with exiting bit head, the heat dissipation area of the bit head is increased, the temperature of the bit bead is reduced, the lifetime of the bit head is longer, and high strength can be maintained all the time during operation of machining. Moreover, the sharp part formed by two top edges can form a positioning center, which may facilitate positioning during operation of machining, improve machining precision, and prevent the problem of bringing up the work pieces when drilling thinner work piece due to unstable positioning.

Embodiment 2

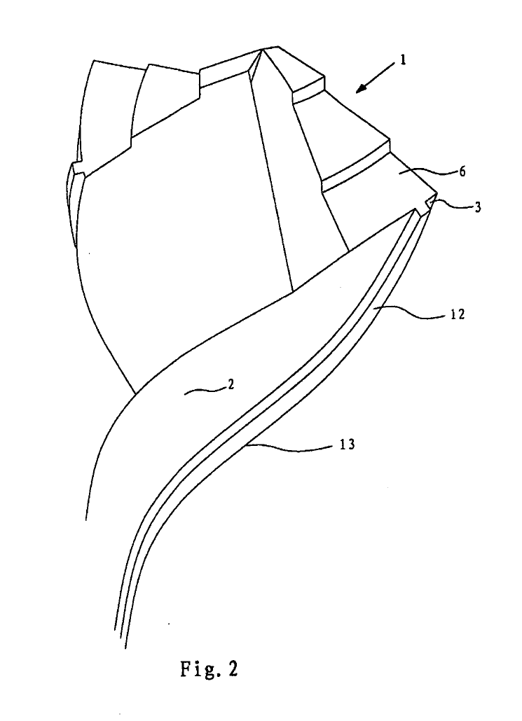

As illustrated in FIG. 2, the helical bit tool in accordance with the second embodiment is substantially the same as that of the first embodiment, except that a heat dissipation stage 12 is formed on the peripheral surface of the helical piece 2 from the top surface 6 of the bit head 1 and is parallel to the side cutting edge 3, and a heat dissipation stage side cutting edge 13 is formed in the front of the heat dissipation stage 12 facing the direction of cutting operation.

By means of this structure, on the basis of the technical effect of the first embodiment, a heat dissipation stage 12 is formed on the peripheral surface of the helical piece 2 from the top surface 6 of the bit head 1 and is parallel to the side cutting edge 3, and a heat dissipation stage side cutting edge 13 is formed in the front of the heat dissipation stage 12 facing the direction of cutting operation, so that in comparison with existing bit head, a new side cutting edge 13 is added and thus the two side cutting edges can work to decompose cutting force of the side cutting edge, reduce friction strength of the side cutting edge so as to reduce heat generated by friction. Meanwhile, the heat dissipation area of the bit head can be increased, the temperature of the bit bead can be reduced, the lifetime of the bit head can be longer, and high strength can be maintained all the time during operation of machining.

Although only one heat dissipation stage 12 is illustrated in the embodiment 2, multiple heat dissipation stages can also be formed. In the case where multiple heat dissipation stages are formed, the dissipation heat stage side cutting edge can be formed in the front of each heat dissipation stage facing the direction of cutting operation.

Embodiment 3

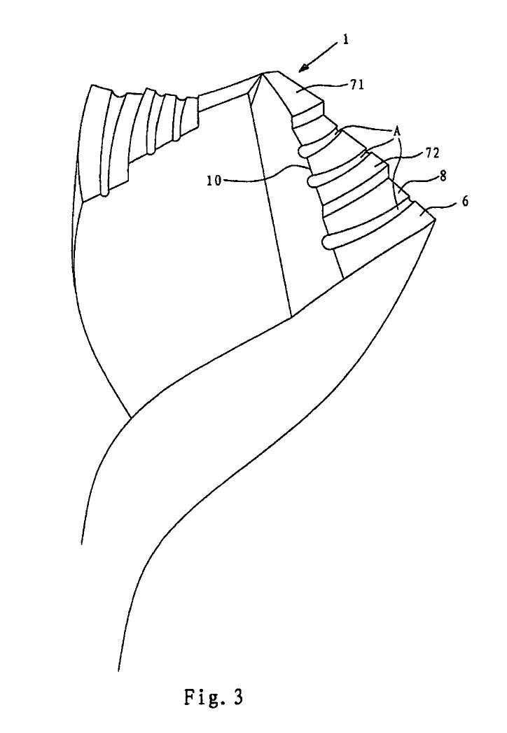

As illustrated in FIG. 3, the helical bit tool in accordance with the third embodiment is substantially the same as that of the first embodiment, except that one arc groove or multiple arc grooves A are formed respectively on each step and the top surface 6 outside the step area. The arc grooves A extend from the main cutting edge 8 to the rear cutting edge 10 with their openings enlarge gradually.

By means of this structure, on the basis of the technical effect of the first embodiment, since one arc groove or multiple arc grooves A are formed respectively on each step and the top surface 6 outside the step area. The arc grooves A extend from the main cutting edge 8 to the rear cutting edge 10 with their openings enlarge gradually, the heat dissipation area can be further increased, and thus the heat dissipation efficiency can be further improved.

Embodiment 4

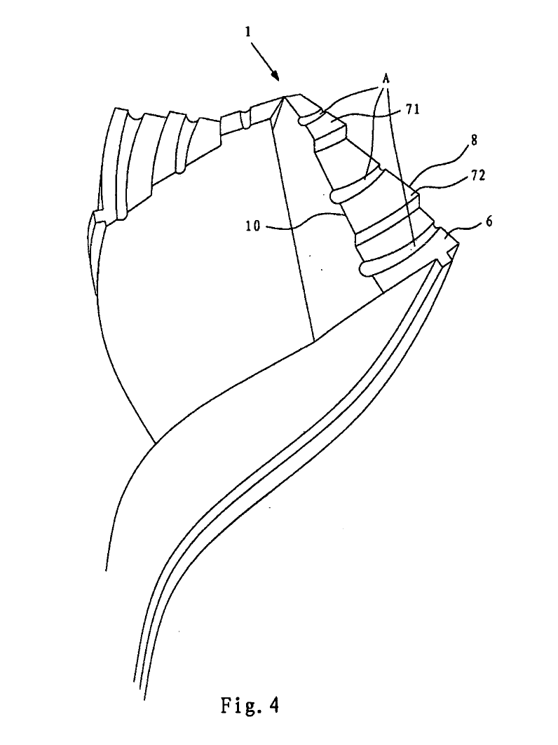

As illustrated in FIG. 4, the helical bit tool in accordance with the fourth embodiment is substantially the same as that of the second embodiment, except that one arc groove or multiple arc grooves A are formed respectively on each step and the top surface 6 outside the step area. The arc grooves A extend from the main cutting edge 8 to the rear cutting edge 10 with their openings enlarge gradually.

By means of this structure, on the basis of the technical effect of the second embodiment, since one arc groove or multiple arc grooves A are formed respectively on each step and the top surface 6 outside the step area. The arc grooves A extend from the main cutting edge 8 to the rear cutting edge 10 with their openings enlarge gradually, the heat dissipation area can be further increased, and thus the heat dissipation efficiency can be further improved.

Embodiment 5

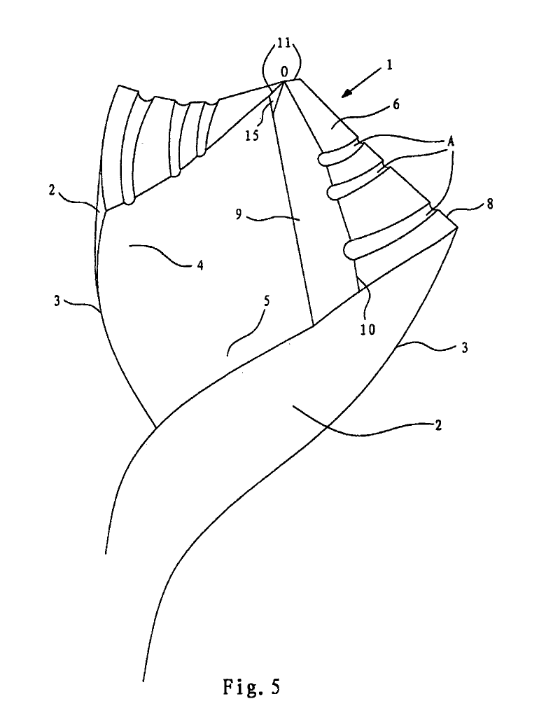

As illustrated by FIG. 5, the helical bit tool in accordance with the fifth embodiment comprises: a bit head 1, the bit head 1 is integratively provided with multiple helical pieces 2, each helical piece 2 has a side cutting edge 3 which faces on the direction of cutting operation. The surface of the side cutting edge 3 which faces on the direction of cutting operation forms a cutting face 4. The back surface of the cutting face 4 forms a rear cutting face 5. A main cutting edge 8 is formed on where the top surface 6 of the bit head 1 interfaces with the cutting face 4. A chamfering surface 9 is formed on where the rear cutting face 5 interfaces with the top surface 6 of the bit head 1. An upright cutting face 15 is formed on the side of the chamfering surface 9 near the center of the top surface. The intersection of the chamfering surface 9 and the top surface 6 of the bit head 1 forms a rear cutting edge 10. The intersection of the upright cutting face 15 and the step area at its back side forms a chisel edge 11. One arc groove or multiple arc grooves A are formed on the top surface 6 and extend from the main cutting edge 8 to the rear cutting edge 10 with their openings enlarge gradually.

According to the above structure, a chamfering surface 9 is formed on where the rear cutting face 5 interfaces with the top surface 6 of the bit head 1, an upright cutting face 15 is formed on the side of the chamfering surface 9 near the center of the top surface, the intersection of the upright cutting face 15 and the step area at its back side forms a chisel edge 11, and one arc groove or multiple arc grooves A are formed on the top surface 6 and extend from the main cutting edge 8 to the rear cutting edge 10 with their openings enlarge gradually, so that in comparison with exiting bit head, the heat dissipation area of the bit head is increased, the temperature of the bit bead is reduced, the lifetime of the bit head is longer, and high strength can be maintained all the time during operation of machining. Moreover, the sharp part formed by two top edges can form a positioning center, which may facilitate positioning during operation of machining, improve machining precision, and prevent the problem of bringing up the work pieces when drilling thinner work piece due to unstable positioning.

Embodiment 6

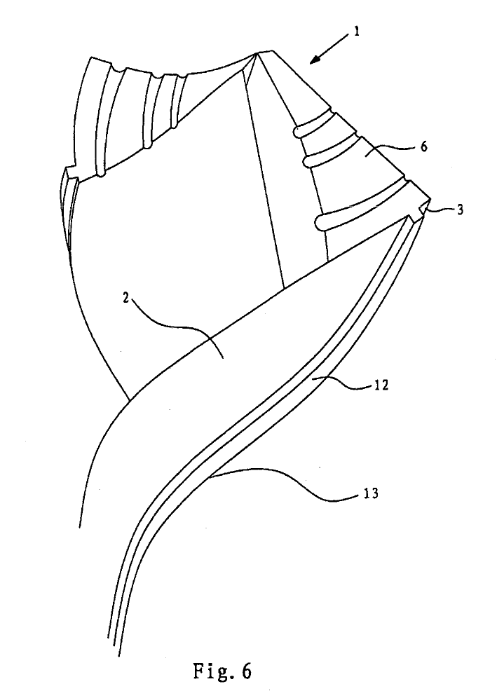

As illustrated in FIG. 6, the helical bit tool in accordance with the sixth embodiment is substantially the same as that of the fifth embodiment, except that a heat dissipation stage 12 is formed on the peripheral surface of the helical piece 2 from the top surface 6 of the bit head 1 and is parallel to the side cutting edge 3, and a heat dissipation stage side cutting edge 13 is formed in the front of the heat dissipation stage 12 facing the direction of cutting operation.

By means of this structure, on the basis of the technical effect of the fifth embodiment, a heat dissipation stage 12 is formed on the peripheral surface of the helical piece 2 from the top surface 6 of the bit head 1 and is parallel to the side cutting edge 3; and a heat dissipation stage side cutting edge 13 is formed in the front of the heat dissipation stage 12 facing the direction of cutting operation, so that in comparison with existing bit head, a new side cutting edge 13 is added and thus the two side cutting edges can work to decompose cutting force of the side cutting edge, reduce friction strength of the side cutting edge so as to reduce heat generated by friction. Meanwhile, the heat dissipation area of the bit head can be increased, the temperature of the bit bead can be reduced, the lifetime of the bit head can be longer, and high strength can be maintained all the time during operation of machining.

Although only one heat dissipation stage 12 is illustrated in the embodiment 6, multiple heat dissipation stages can also be formed. In the case where multiple heat dissipation stages are formed, the dissipation heat stage side cutting edge can be formed in the front of each heat dissipation stage facing the direction of cutting operation.

Embodiment 7

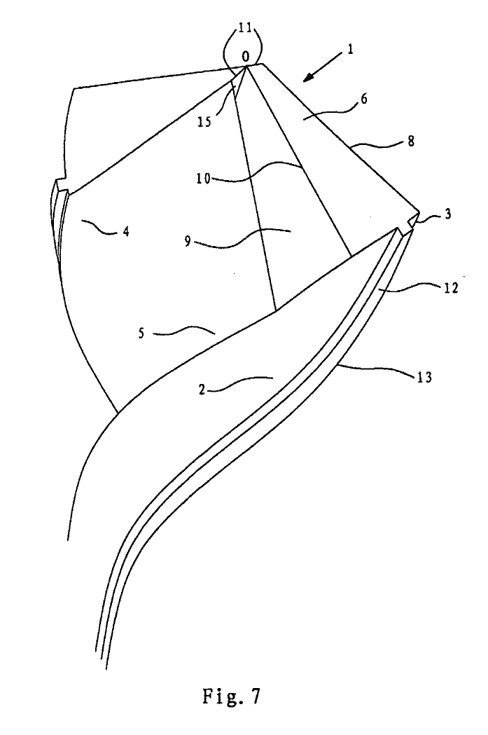

As illustrated in FIG. 7, the helical bit tool in accordance with the seventh embodiment of the present invention comprises: a bit head 1, the bit head 1 is integratively provided with multiple helical pieces 2, each helical piece 2 has a side cutting edge 3 which faces on the direction of cutting operation. The surface of the side cutting edge 3 which faces on the direction of cutting operation forms a cutting face 4. The back surface of the cutting face 4 forms a rear cutting face 5. A main cutting edge 8 is formed on where the top surface 6 of the bit head 1 interfaces with the cutting face 4. A chamfering surface 9 is formed on where the rear cutting face 5 interfaces with the top surface 6 of the bit head 1. An upright cutting face 15 is formed on the side of the chamfering surface near the center of the top surface. The intersection of the chamfering surface 9 and the top surface 6 of the bit head 1 forms a rear cutting edge 10. The intersection of the upright cutting face 15 and the step area at its backside forms a chisel edge 11. A heat dissipation stage 12 is formed on the peripheral surface of the helical pieces 2 from the top surface 6 of the bit head 1 and is parallel to the side cutting edge 3. A heat dissipation stage side cutting edge 13 is formed in the front of the heat dissipation stage 12 facing the direction of cutting operation.

According to the above structure, a chamfering surface 9 is formed on where the rear cutting face 5 interfaces with the top surface 6 of the bit head 1. An upright cutting face 15 is formed on the side of the chamfering surface near the center of the top surface. The intersection of the upright cutting face 15 and the step area at its backside forms a chisel edge 11. A heat dissipation stage 12 is formed on the peripheral surface of the helical pieces 2 from the top surface 6 of the bit head 1 and is parallel to the side cutting edge 3. A heat dissipation stage side cutting edge 13 is formed in the front of the heat dissipation stage 12 facing the direction of cutting operation, so that compared with existing bit head, a new side cutting edge 13 is added and thus the two side cutting edges can work to decompose cutting force of the side cutting edge, reduce friction strength of the side cutting edge so as to reduce the heat generated by friction. Meanwhile, the heat dissipation area of the bit head can be increased, the temperature of the bit bead can be reduced, the lifetime of the bit head can be longer, and high strength can be maintained all the time during operation of machining. Moreover, the sharp part formed by two top edges can form a positioning center, which may facilitate positioning during operation of machining, improve machining precision, and prevent the problem of bringing up the work pieces when drilling thinner work piece due to unstable positioning.

Although only one heat dissipation stage 12 is illustrated in the embodiment 7, multiple heat dissipation stages can also be formed. In the case where multiple heat dissipation stages are formed, the dissipation heat stage side cutting edge can be formed in the front of each heat dissipation stage facing the direction of cutting operation.

Embodiment 8

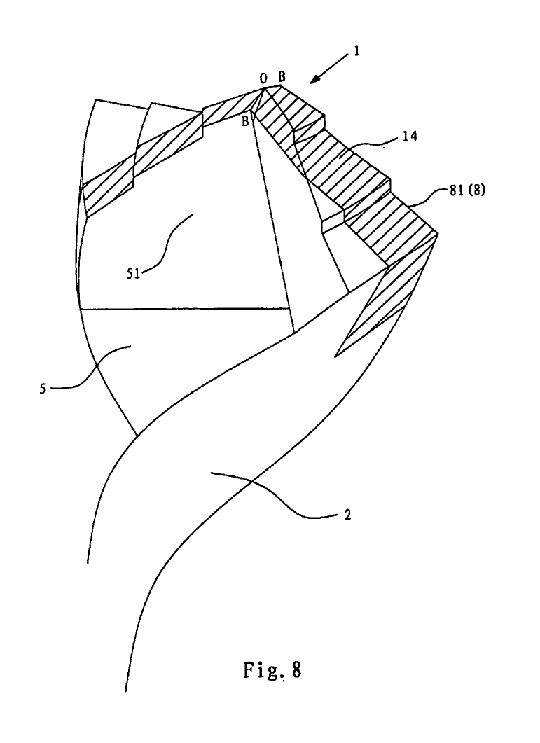

As illustrated in FIG. 8, the helical bit tool in accordance with the eighth embodiment of the present invention is substantially the same as that of the embodiments 1-7, except that two helical pieces 2 are formed, and an alloy bit head 14 with uniform thickness is clipped on the bit head 1, which penetrates the bit head and is symmetry with respect to the center O of the top surface. Two faces of the alloy bit head 14 facing the direction of cutting operation pass through two intersections B, B of the top edge and the main cutting edge, respectively. The face 51 of the alloy bit head 14 facing the direction of cutting operation forms an upper part of the cutting surface 5, and the cutting edge 81 facing the direction of cutting operation forms the main cutting edge 8.

According to the above structure, on the basis of the technical effect of the embodiments 1-7, an alloy bit head 14 with uniform thickness is clipped on the bit head 1, which penetrates the bit head 1 and is symmetry with respect to the center O of the top surface, two faces of the alloy bit head 14 facing the direction of cutting operation pass through two intersections B, B of the top edge and the main cutting edge, the face 51 of the alloy bit head 14 facing the direction of cutting operation forms an upper part of the cutting surface 5, and the cutting edge 81 facing the direction of cutting operation forms the main cutting edge 8, so that in comparison with existing bit head, strength of the bit head is enhanced, the cutting edge is sharper, so that the lifetime of the bit tool can be longer, high strength can be maintained throughout the machining, and production efficiency can be improved.

Although description is made with reference to the bit tool with two helical pieces, the bit tool according to the present invention can have more helical pieces, to which structures of the above embodiments and any combinations thereof can be applied.

The preferred embodiments described above are just illustrative and are not intend to be limiting. The present invention can be implemented and embodied in other manners without departing from the spirit and basic features of the present invention. The scope of the present invention is defined by the claims and all alterations within the scope as defined by the claims fall within the scope of the present invention.

The claims:

1. A helical bit tool, comprising a bit head, characterizing in that: the bit head is integratively provided with multiple helical pieces, each helical piece has a side cutting edge which faces the direction of cutting operation, the surface of the side cutting edge which faces the direction of cutting operation forms a cutting face, the back surface of the cutting face forms a rear cutting face,
step area is formed on the top surface of the bit head, in which a step or multiple steps are formed with progressively lower heights from the center of the top surface to the outer flank, the periphery of every step is inclined with respect to the periphery of the bit head, a main cutting edge is formed on where the cutting face interfaces with the step area and the top surface of the bit head,
a chamfering surface is formed on where the rear cutting face interfaces with the step area and the top surface of the bit head, an upright cutting face is formed on the side of the chamfering surface near the center of the top surface, the intersection of the chamfering surface with the step area and the top surface of the bit head forms a rear cutting edge. The intersection of the upright cutting face and the step area at its back side forms a chisel edge.

2. The helical bit tool of claim 1, characterized in that: one heat dissipation stage or multiple heat dissipation stages are formed on the peripheral surface of the helical pieces from the top surface of the bit head and are parallel to the side cutting edge, one heat dissipation stage side cutting edge or multiple heat dissipation stage side cutting edges are formed in the front of the heat dissipation stage facing the direction of cutting operation.

3. The helical bit tool of claim 1, characterized in that: one arc groove or multiple arc grooves are formed respectively on each step and the top surface outside the step area, and the arc grooves extend from the main cutting edge to the rear cutting edge with their openings enlarge gradually.

4. The helical bit tool of claim 2, characterized in that: one arc groove or multiple arc grooves are formed respectively on each step and the top surface outside the step area, and the arc grooves extend from the main cutting edge to the rear cutting edge with their openings enlarge gradually.

5. A helical bit tool, comprising a bit head, characterizing in that: the bit head is integratively provided with multiple helical pieces, each helical piece has a side cutting edge which faces the direction of cutting operation, the surface of the side cutting edge which faces the direction of cutting operation forms a cutting face, the back surface of the cutting face forms a rear cutting face, a main cutting edge is formed on where the top surface of the bit head interfaces with the cutting face,
a chamfering surface is formed on where the rear cutting face interfaces with the top surface of the bit head, an upright cutting face is formed on the side of the chamfering surface near the center of the top surface, t he intersection of the chamfering surface and the top surface of the bit head forms a rear cutting edge, the intersection of the upright cutting face and the step area at its back side forms a chisel edge,
one arc groove or multiple arc grooves are formed on the top surface and extend from the main cutting edge to the rear cutting edge with their openings enlarge gradually.

6. The helical bit tool of claim 5, characterized in that: one heat dissipation stage or multiple heat dissipation stages are formed on the peripheral surface of the helical pieces from the top surface of the bit head and are parallel to the side cutting edge, one heat dissipation stage side cutting edge or multiple heat dissipation stage side cutting edges are formed in the front of the heat dissipation stage facing the direction of cutting operation.

7. A helical bit tool, comprising a bit head, characterizing in that: the bit head is integratively provided with multiple helical pieces, each helical piece has a side cutting edge which faces on the direction of cutting operation, the surface of the side cutting edge which faces on the direction of cutting operation forms a cutting face, the back surface of the cutting face forms a rear cutting face, a main cutting edge is formed on where the top surface of the bit head interfaces with the cutting face,
a chamfering surface is formed on where the rear cutting face interfaces with the top surface of the bit head, an upright cutting face is formed on the side of the chamfering surface near the center of the top surface, t he intersection of the chamfering surface and the top surface of the bit head forms a rear cutting edge, the intersection of the upright cutting face and the step area at its backside forms a chisel edge,
one heat dissipation stage or multiple heat dissipation stages are formed on the peripheral surface of the helical pieces from the top surface of the bit head and are parallel to the side cutting edge, one heat dissipation stage side cutting edge or multiple heat dissipation stage side cutting edges are formed in the front of the heat dissipation stage facing the direction of cutting operation.

8. The helical bit tool of any one of claims 1-7, characterized in that: two helical pieces are formed, and an alloy bit head with uniform thickness is clipped on the bit head, which penetrates the bit head and is symmetry with respect to the center of the top surface, two faces of the alloy bit head facing the direction of cutting operation pass through two intersections of the top edge and the main cutting edge respectively, the face of the alloy bit head facing the direction of cutting operation forms an upper part of the cutting surface, and the cutting edge facing the direction of cutting operation forms the main cutting edge.
